(19) United States
(12) Patent Application Publication
(10) Pub. No.: US 2019/0114558 A1
(43) Pub. Date: Apr. 18, 2019

(54) INFORMATION PROCESSING APPARATUS, INFORMATION PROCESSING METHOD, AND PROGRAM

(71) Applicant: SONY CORPORATION, TOKYO (JP)

(72) Inventors: NOBUHIRO OGAWA, TOKYO (JP); KATSUYOSHI KANEMOTO, CHIBA (JP); ATSUSHI NODA, TOKYO (JP); TAKUYA FUJITA, KANAGAWA (JP)

(21) Appl. No.: 16/094,032

(22) PCT Filed: Apr. 7, 2017
(86) PCT No.: PCT/JP2017/014451

§ 371 Date: Oct. 16, 2018

(30) Foreign Application Priority Data
Apr. 22, 2016 (JP) 2016-086116

(51) Int. Cl. G06N 20/00; G06N 5/04

(52) U.S. Cl. CPC G06N 20/00; G06F 3/0482; G06N 5/043

(57) ABSTRACT

The present disclosure relates to an information processing apparatus, an information processing method, and a program by which learning data can be transferred to another agent. In a case of transferring learning data to another user, the learning data is divided into learning data of a private type depending on an individual and learning data of a public type excluding it and only learning data of the public type is only transferred. In a case of transferring it to an agent of a new vehicle, it is classified into individual-dependent data, vehicle type-dependent data, and general-purpose data and only the general-purpose data is transferred. Only in a case where a vehicle type of the new vehicle is the same as the vehicle type which has been used at that time, the vehicle type-dependent data is also transferred. The present disclosure can be applied to intelligent agents.

### TECHNICAL FIELD

The present disclosure relates to an information processing apparatus, an information processing method, and a program, and more particularly to an information processing apparatus, an information processing method, and a program by which learning data accumulated in hardware can be easily transferred.

### BACKGROUND ART

There is known an “intelligent agent” that recognizes a condition of an environment on the basis of detection results of various sensors, reasons on a next operation, and performs an operation according to the result of reasoning (see Non-Patent Literature 1).

Various intelligent agents exist. As a specific example, when a user inputs literal characters in an electronic device such as a personal computer and a smartphone, for example, an intelligent agent displays highly possible candidates in accordance with learning based on an input history so as to be selected by the user.

That is, since the intelligent agent cannot completely obtain descriptions regarding unknown environments, the intelligent agent performs learning to obtain acknowledge of the unknown environments from experience, accumulates the learning results, repeats reasoning, and performs an operation in accordance with the result of reasoning.

### CITATION LIST

### Non-Patent Literature

Non-Patent Literature 1: Intelligent Agent Internet <URL: http://www2c.comm.eng.osaka-u.ac.jp/˜babaguchi/aibook/agent.pdf>

### DISCLOSURE OF INVENTION

### Technical Problem

However, for example, in a case where the hardware with the intelligent agent installed therein is replaced by buying other hardware, the accumulated learning results such as personal-history data described above are erased for protecting privacy when a user is changed. Thus, a user of the new hardware cannot utilize the accumulated learning results with an intelligent agent of the new hardware.

Moreover, in a case where a new user starts to use old hardware, since learning results accumulated by a previous user are erased for protecting privacy, no learning results remain and learning should be performed again in the initial state.

Thus, in general, even if learning results acquired by an intelligent agent through learning in the past include information useful to a new user, the accumulated learning results cannot be used, and it is impossible to take benefits which should be obtained from the learning results.

The present disclosure has been made in view of the above-mentioned circumstances particularly to enable learning results which have been acquired by an intelligent agent or the like installed in hardware through learning to be transferred in a suitable state even if a user of the hardware changes or new hardware is used.

### Solution to Problem

An information processing apparatus according to an aspect of the present disclosure is an information processing apparatus including: a storage unit that stores learning data in association with a user who uses hardware; an operation determination unit that determines an operation of the hardware on a basis of the learning data; and a presentation unit that presents an option of learning data available to the user out of the learning data stored in the storage unit, in which the operation determination unit determines an operation on a basis of learning data selected from the option presented by the presentation unit.

The learning data can include private data depending on the user and public data other than the private data, and the presentation unit can present the public data as an option as learning data available to the operation determination unit out of the learning data stored in the storage unit.

The learning data can include individual-dependent data depending on an individual of the hardware, type-dependent data depending on a type of the hardware, and general-purpose data not depending on the hardware, and the presentation unit can present, when the user uses other hardware different from the hardware and causes the operation determination unit of the other hardware to determine an operation, options including private data and public data of the general-purpose data out of learning data stored in association with the hardware. The learning data set forth herein refers to various types of data acquired from the hardware when the user uses the hardware. Moreover, the various types of data acquired from the hardware includes data acquired on the basis of operations of respective devices included in the hardware and software.

In a case where the hardware and the other hardware are of a same type, the presentation unit can present, when the user uses other hardware different from the hardware and causes the operation determination unit of the other hardware to determine an operation, options including private data and public data of each of the type-dependent data and the general-purpose data out of learning data stored in association with the other hardware.

The presentation unit can present options for discarding each of the private data and the public data of the individual-dependent data, the type-dependent data, and the general-purpose data out of the learning data.

The learning data can be constructed for each hardware module used by the user, and the presentation unit can present another option for selecting the hardware to which the learning data is to be transferred, and an option of the learning data available to the operation determination unit of the hardware, the option being public data of learning data learned by the hardware used by the user out of the learning data stored in the storage unit.

The learning data is constructed for each hardware module used by the user and includes individual-dependent data depending on an individual of the hardware, type-dependent data depending on a type of the hardware, and general-purpose data not depending on the hardware, and the presentation unit can present another option for selecting the hardware to which the learning data is to be transferred, and options of the learning data available to the operation determination unit of another hardware different from the hardware, the options being public data and private data of the general-purpose data of learning data learned by the hardware used by the user out of the learning data stored in the storage unit.

The hardware can be a vehicle, the learning data includes individual-dependent data depending on an individual of the vehicle, vehicle type-dependent data depending on four vehicle types of the vehicle, and general-purpose data not depending on the vehicle, the individual-dependent data can include a repair history, a distance travelled, remodeling information, a collision history, and a residual amount of gasoline, the vehicle type-dependent data can include fuel consumption, a maximum speed, information regarding whether or not travelling on a route navigated is possible, sensing data for detecting a vehicle operation, information regarding whether or not automatic driving is possible, and a route travelled in automatic driving, which are commonly determined for each vehicle type of the vehicle, and the general-purpose data can include route information, near-store information, a visited-place history, a history of conversation with an agent, a drive manner, heavy braking, number of honking times, smoking or no-smoking, weather, three-dimensional data regarding a building, a road, and the like, and external information.

The information processing apparatus can include an anonymization unit that anonymizes data regarding an operation determined on a basis of the learning data, in which the storage unit can store the data regarding the operation determined on the basis of the learning data by the operation determination unit in a state in which the data is anonymized by the anonymization unit.

An information processing method according to an aspect of the present disclosure is an information processing method for an information processing apparatus including a storage unit that stores learning data in association with a user who uses hardware, an operation determination unit that determines an operation of the hardware on a basis of the learning data, and a presentation unit that presents an option of learning data available to the user out of the learning data stored in the storage unit, the information processing method including: a step of determining, by the operation determination unit an operation on a basis of learning data selected from the option presented by the presentation unit.

A program according to an aspect of the present disclosure is a program for a computer including a storage unit that stores learning data in association with a user who uses hardware, an operation determination unit that determines an operation of the hardware on a basis of the learning data, and a presentation unit that presents an option of learning data available to the user out of the learning data stored in the storage unit, the program causing the computer to execute processing of determining, by the operation determination unit an operation on a basis of learning data selected from the option presented by the presentation unit.

In an aspect of the present disclosure, learning data is stored in association with a user who uses hardware, an operation of the hardware is determined on the basis of the learning data, an option of learning data available to the user out of the learning data stored in the storage unit is presented, and an operation is determined on the basis of learning data selected from the presented option.

### Advantageous Effects of Invention

In accordance with an aspect of the present disclosure, learning results which have been acquired by an intelligent agent or the like installed in hardware through learning can be transferred in a suitable state even if a user of the hardware changes or new hardware is used.

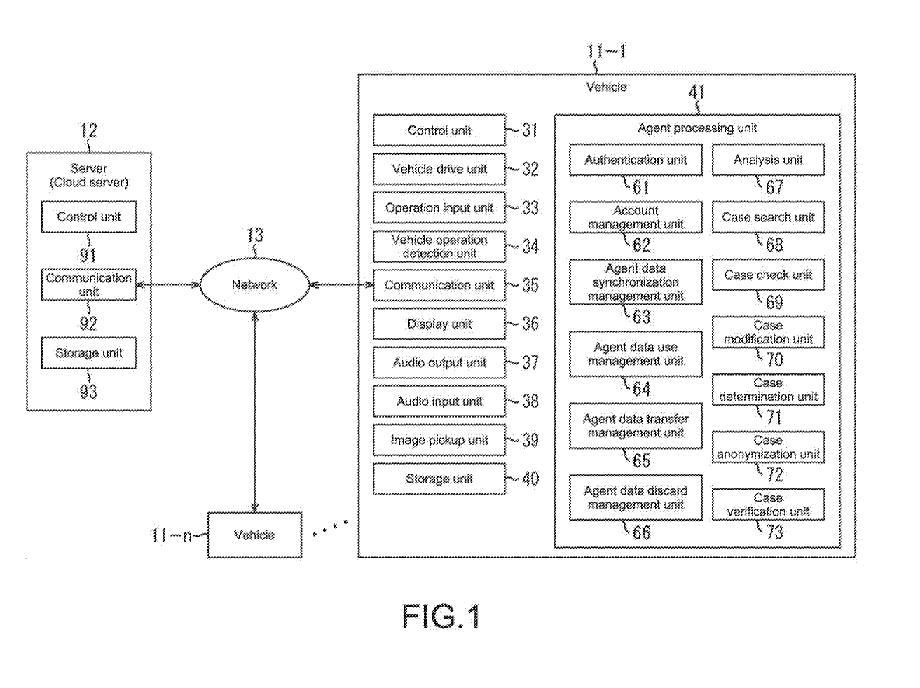

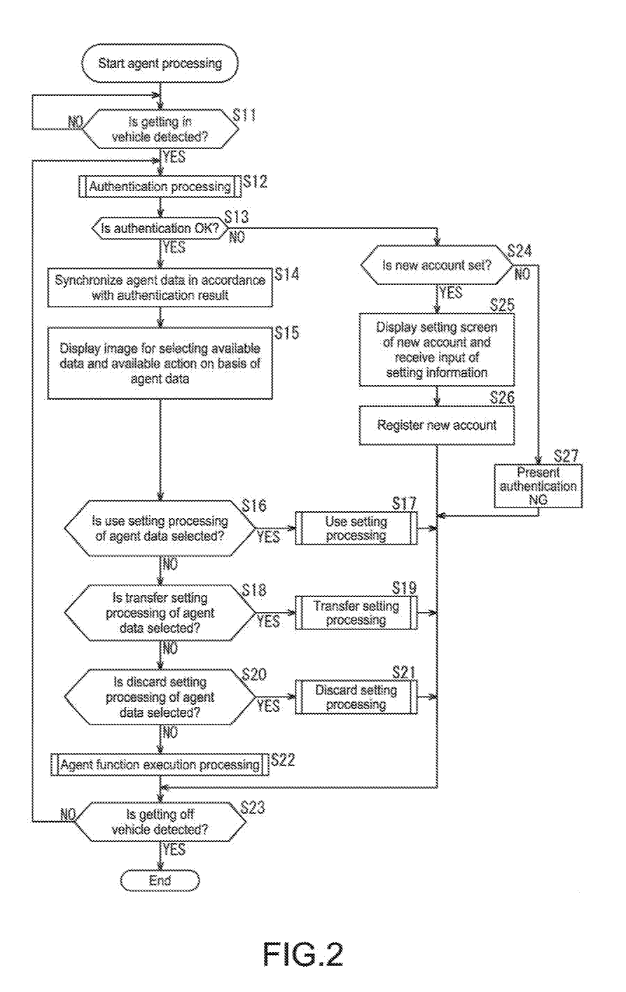

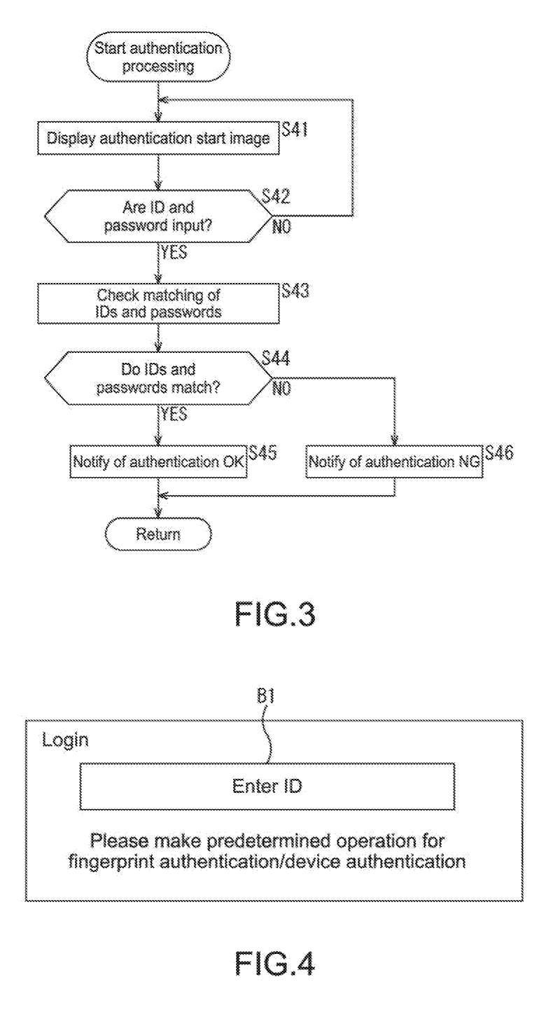

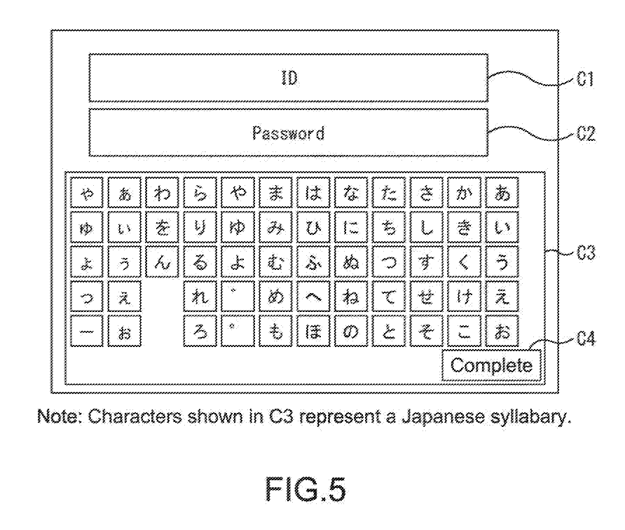

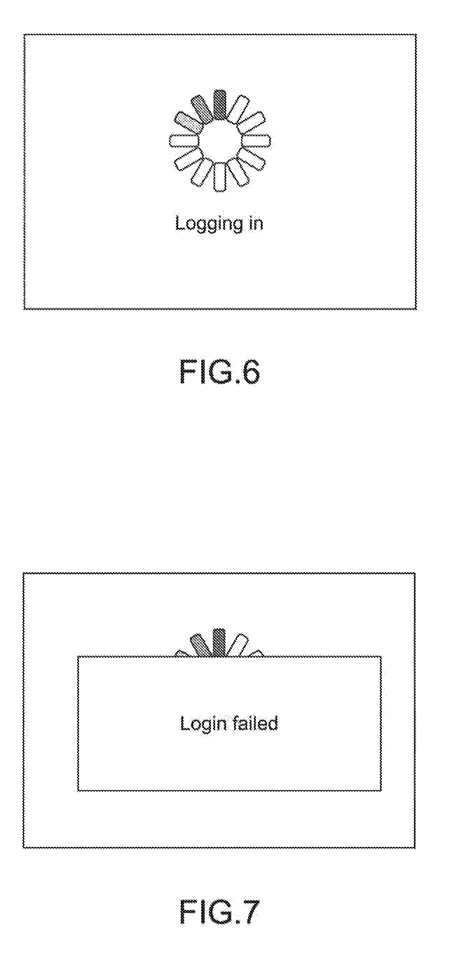

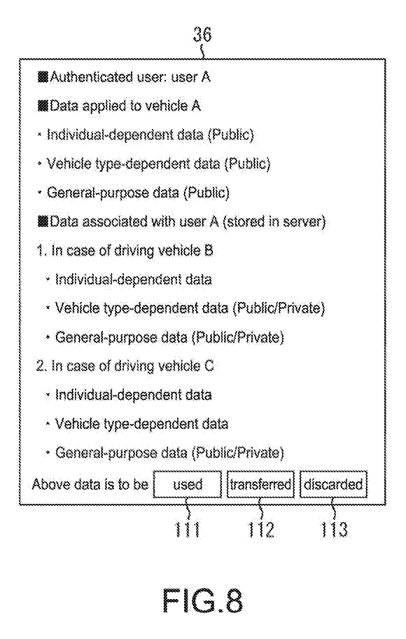

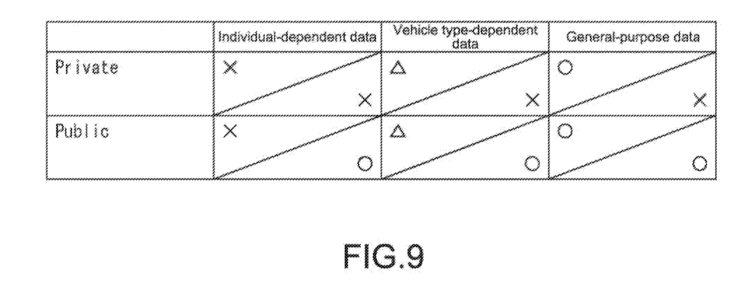

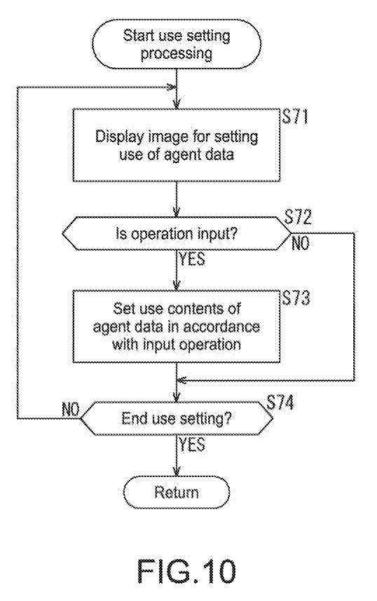

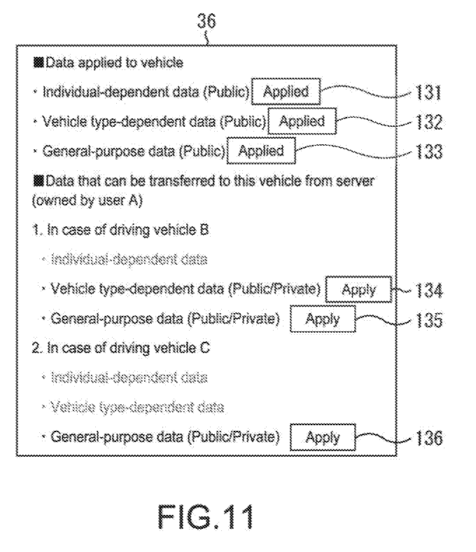

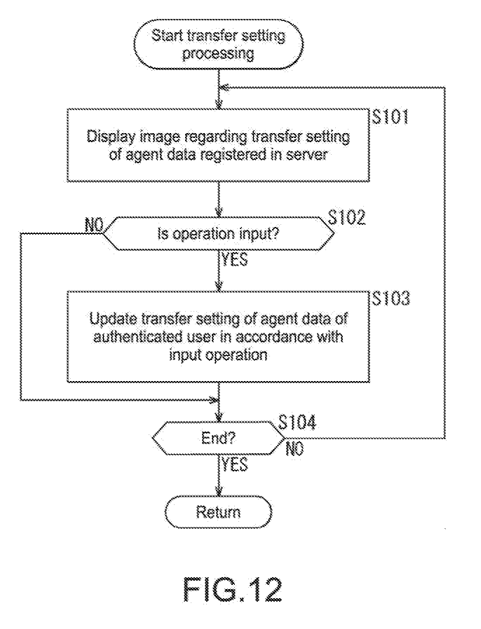

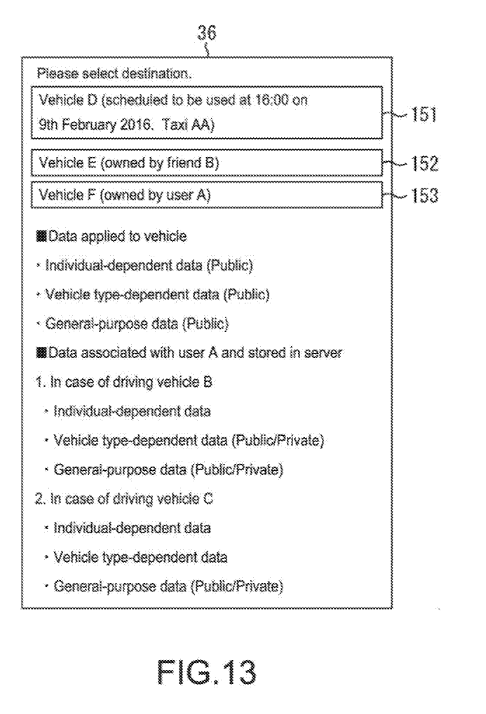

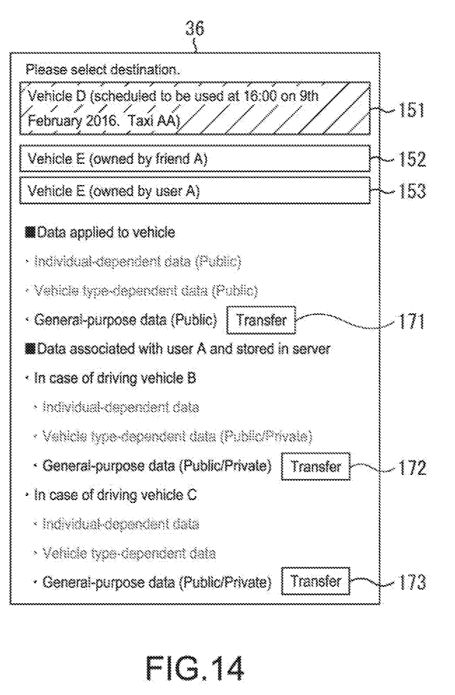

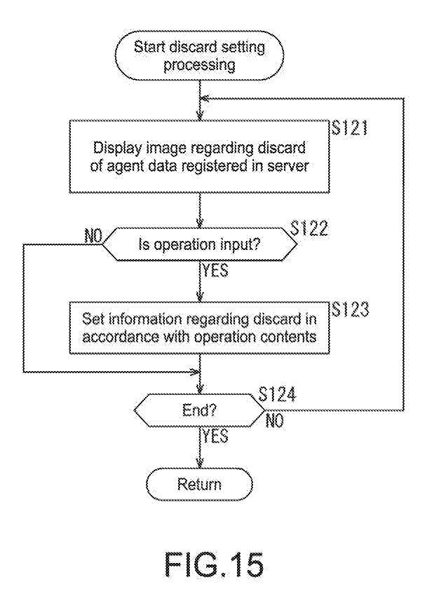

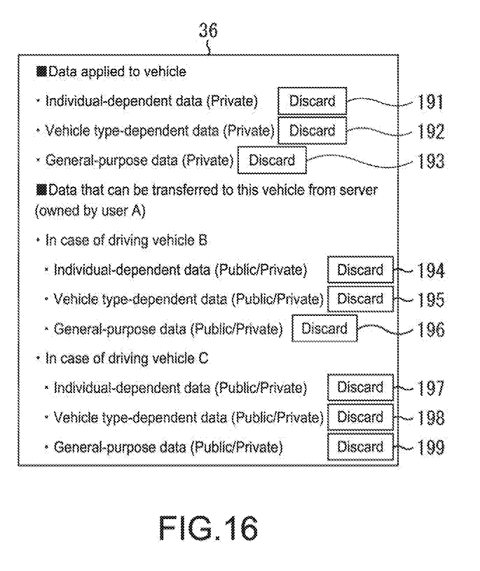

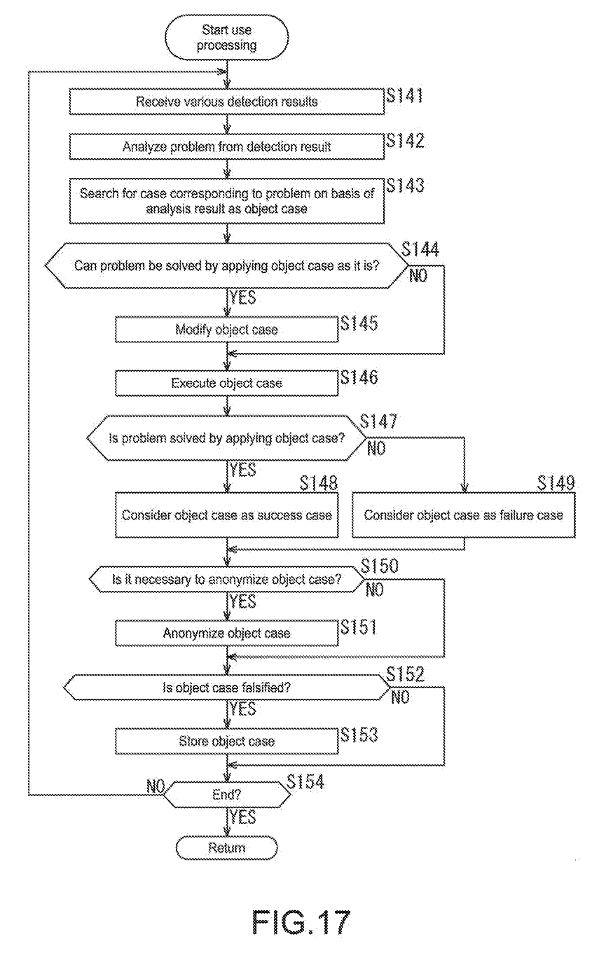

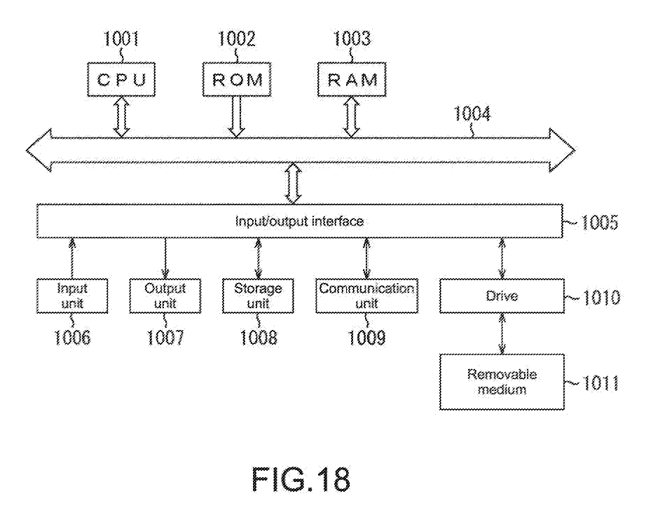

### BRIEF DESCRIPTION OF DRAWINGS

[FIG. 1] A diagram showing a configuration example of an agent system including a vehicle and a server to which the present disclosure is applied.

[FIG. 2] A flowchart describing agent processing by the vehicle of FIG. 1.

[FIG. 3] A flowchart describing authentication processing of FIG. 2.

[FIG. 4] A diagram describing the authentication processing of FIG. 3.

[FIG. 5] A diagram describing the authentication processing of FIG. 3.

[FIG. 6] A diagram describing the authentication processing of FIG. 3.

[FIG. 7] A diagram describing the authentication processing of FIG. 3.

[FIG. 8] A diagram describing an image for displaying available agent data and available actions.

[FIG. 9] A diagram describing a rule associated with transfer of the agent data.

[FIG. 10] A flowchart describing use setting processing of FIG. 2.

[FIG. 11] A diagram describing the use setting processing of FIG. 10

[FIG. 12] A flowchart describing transfer setting processing of FIG. 2.

[FIG. 13] A diagram describing the transfer setting processing of FIG. 12.

[FIG. 14] A diagram describing the transfer setting processing of FIG. 12.

[FIG. 15] A flowchart describing discard setting processing of FIG. 2.

[FIG. 16] A diagram describing the discard setting processing of FIG. 15.

[FIG. 17] A flowchart describing agent function execution processing of FIG. 2.

[FIG. 18] A diagram describing a configuration example of a general-purpose personal computer.

### MODE(S) FOR CARRYING OUT THE INVENTION

Hereinafter, a suitable embodiment of the present disclosure will be described in detail with reference to the accompanying drawings. It should be noted that in the present specification and the drawings, components having substantially the same functional configurations will be denoted by the same signs and duplicate descriptions thereof will be omitted.

<Configuration Example of Agent System Including Vehicle with Agent Installed Therein and Server that Manages Agent Data>

FIG. 1 shows a configuration example of an agent system including vehicles each installing an agent therein, to which an information processing apparatus of the present disclosure is applied, and a server that manages agent data.

Vehicles 11-1 to 11-n of FIG. 1 each install an agent therein, which executes processing according to a request from a user who is a driver. The agent performs various types of driving assistance for users who use the vehicles 11-1 to 11-n, for example. For example, the agent realizes a navigation function for guidance to a destination, a driving support function for guidance about accelerator work and brake work for improving fuel consumption, and the like.

It should be noted that although in this embodiment, it is assumed that particularly when the user who is a driver uses the vehicle 11, the agent functions as a navigation apparatus that searches for a route to a desired destination and guides the user, the agent may realize other functions.

Moreover, hereinafter, the vehicles 11-1 to 11-n will be simply referred to as vehicles 11 unless specifically required to be distinguished one from the other and the same applies to other configurations.

At this time, while performing general route search based on map information or the like, the agent searches for a route excluding a route whose road width is narrow to a vehicle width and which is difficult to handle on the basis of information about a vehicle size and the like, for example. Moreover, for example, if there is a history or the like of a stop (through-point) frequently set when a predetermined destination is set in a particular time zone, the agent searches for a route including the frequently set stop only by the destination being set at the particular time. That is, when the driver searches for a route to a desired destination, the agent repeats learning depending on the habit and history of the driver and the condition of the vehicle 11, which are associated with route search, and executes route search based on the learning results to thereby execute route search optimal for the driver.

More specifically, the agent stores the learning results as the agent data in a server 12 including a cloud server and the like via a network 13 represented by the Internet while the agent data is associated with the driver and the vehicle. Moreover, the agent authenticates the driver, accesses the server 12 on the basis of the authentication result, and reads and uses the agent data associated therewith for route search or the like.

Since that agent data is associated with the driver and the vehicle, even in a case where a driver P changes vehicles from a vehicle A to a vehicle B, for example, agent data to be used in a manner that depends on the driver can be transferred from the vehicle A to the vehicle B and used. At this time, the search results of the route search, the learning results of the history, and the like which are included in the agent data can be transferred as they are. Meanwhile, for example, regarding the vehicle size and the like, those of the new vehicle B are employed.

In addition, regarding the agent data associated with the vehicle A, for example, a history indicating that the vehicle A has travelled at the top of Mt. Fuji, a special history indicating that the vehicle A has travelled in a special region, for example, a special history indicating that the vehicle A has travelled across North America, and the like are can be kept as personal information in a state in which those histories cannot be identified. In a case where a new driver Q succeeds to and drives the vehicle A, those histories can be put in a recognizable state. Moreover, in the agent data associated with the vehicle A, a repair history, an accident history, and the like of the vehicle A can also be kept as special history. The special history included in this agent data can be used as added-value information of the vehicle A.

That is, in this special history, the history indicating that the vehicle A has travelled at the top of Mt. Fuji and the special history indicating that the vehicle A has travelled in the special region, for example, the special history indicating that the vehicle A has travelled across North America can be used as information that increases a special value (that increases the added-value) of the vehicle A. Moreover, the repair history, the accident history, and the like out of this special history can be used as information that lowers the added-value to the vehicle A.

As a result, although a distance travelled, years of use, and a vehicle's history such as a repair history and an accident history which are also included in the special history is typically used as an index for determining by what degree the added-value of the vehicle A is lowered in a case where the vehicle A is sold, the histories that increases the special value (that increases the added-value) out of the special history can be used as an index for increasing the value of the vehicle A.

Here, a configuration example of the vehicle 11 will be described.

The vehicle 11 includes a control unit 31, a vehicle drive unit 32, an operation input unit 33, a vehicle operation detection unit 34, a communication unit 35, a display unit 36, an audio output unit 37, an audio input unit 38, an image pickup unit 39, a storage unit 40, and an agent processing unit 41.

The control unit 31 is a computer including a so-called engine control unit (ECU) and the like and generally controls operations of the vehicle 11.

The vehicle drive unit 32 is a general term of an engine, an accelerator, a brake, an air conditioner, an illumination system, and the like which are included in the vehicle 11, and an operation thereof is controlled by the control unit 31. The control unit 31 may control automatic driving of the vehicle 11. In this case, the control unit 31 realizes the automatic driving by controlling the vehicle drive unit 32.

The operation input unit 33 is a button, a touch panel, and the like for inputting various types of information into the agent controlled by the agent control unit 41. The operation input unit 33 is operated by a driver who is a user and outputs an operation signal depending on the operation contents.

The vehicle operation detection unit 34 includes various sensors in the vehicle 11. The vehicle operation detection unit 34 detects the presence/absence of an automatic brake operation, the presence/absence of a collision, and the like as well as yaw, pitch, and roll of a three-dimensional acceleration sensor.

The communication unit 35 includes an Ethernet (registered trademark) board and the like. The communication unit 35 communicates with the server 12 via the network 13 and sends and receives various types of data.

The display unit 36 is a display including a liquid crystal display (LCD), an organic electro luminescence (EL), and the like, and displays various types of information.

The audio output unit 37 includes a speaker and the like and outputs various types of information as audio. That is, the audio output unit 37 outputs, as audio, information regarding route guidance in a car navigation function of the agent which is realized by actuation of the agent processing unit 41, for example.

The audio input unit 38 includes a microphone and the like, and receives driver's instruction contents as audio as in the operation input unit 33.

The image pickup unit 39 includes an image pickup element such as a complementary metal oxide semiconductor (CMOS). The image pickup unit 39 picks up images of a front side, a rear side, lateral rear sides, a bottom side of the vehicle 11 in a travel direction, an area inside the vehicle, all surroundings of the vehicle, and a driver's face, and the like, and outputs picked-up image signals.

The storage unit 40 includes a flash memory and the like. The storage unit 40 reads and stores the agent data stored in the server 12 and is rewritten as appropriate in a manner that depends on processing of the agent processing unit 41. It should be noted that the agent data stored in the storage unit 40 is stored in the server 12 in a manner that depends on needs.

The agent processing unit 41 realizes the above-mentioned agent function. The agent processing unit 41 includes an authentication unit 61, an account management unit 62, an agent data synchronization management unit 63, an agent data use management unit 64, an agent data transfer management unit 65, an agent data discard management unit 66, an analysis unit 67, a case search unit 68, a case check unit 69, a case modification unit 70, a case determination unit 71, a case anonymization unit 72, and a case verification unit 73.

In a case where the user who is a driver gets in the vehicle 11, the authentication unit 61 performs authentication as to whether or not the user is a registered user by using an ID and a password input by operating the operation input unit 33, for example. Moreover, for example, on the basis of a driver's face image picked up by the image pickup unit 39, the authentication unit 61 may perform authentication as to whether or not the user is a user who is a registered driver. In addition, otherwise, the authentication unit 61 may perform authentication by using a user's retina pattern or fingerprint whose the image is picked up by the image pickup unit 39 or may perform authentication by using a user's voice spectrum input via the audio input unit 38.

The account management unit 62 manages an account of a user who is a driver who manages the agent data regarding the vehicle 11. More specifically, in a case where the user is a driver whose authentication has not been confirmed by the authentication unit 61, i.e., a new driver, the account management unit 62 registers the user who is the driver as an account. Moreover, an account of each vehicle 11 is typically set while the account is associated with a driver who is a user who is an owner.

In a case where a next owner is not present, for example, in a case where the vehicle 11 is sold, the account is not present. However, the data depending on the individual vehicle 11, for example, the distance travelled and repair information of the vehicle 11 need to be managed in association with the vehicle 11 even in the state in which the account of the driver is not present. Therefore, in such a case, the account management unit 62 may set a temporary account and may manage the individual-dependent data in the server 12 in association with the temporary account also in the state in which the driver is not registered, such that the individual-dependent data can be managed until a driver who is a new owner is registered. In this case, the registered temporary account is eliminated, and the new driver is managed in the server 12 in association with an account for which the driver is set.

The agent data synchronization management unit 63 accesses the server 12 on the basis of the authentication result and information for identifying the vehicle 11, synchronizes and reads the agent data which is of the authenticated user and which is stored in association with the vehicle 11, and stores it in the storage unit 40.

The agent data use management unit 64 executes use setting processing of the agent data stored in the storage unit 40 and performs use setting depending on the operation contents of the operation input unit 33.

For example, in a case where the user changes vehicles from the vehicle 11 to a new vehicle 11 by, for example, replacing the vehicle 11 by buying the new vehicle 11, the agent data transfer management unit 65 executes transfer setting processing of transferring the agent data to the new vehicle 11 and performs transfer setting depending on the operation contents of the operation input unit 33.

The agent data discard management unit 66 executes discard setting processing, receives an operation by the operation input unit 33, and performs discard setting of data of the agent data in accordance with an instruction to discard the data.

When the agent data stored in the storage unit 40 is used by the agent data use management unit 64 and the function as the agent is executed, the analysis unit 67 analyzes the condition of the vehicle 11 and determines a case that becomes a problem on the basis of information regarding various detection results supplied from the operation input unit 33, the vehicle operation detection unit 34, and the image pickup unit 39.

The case search unit 68 searches for the case analyzed by the analysis unit 67 from the cases accumulated as the agent data, and outputs the searched case as an object case.

The case check unit 69 checks whether or not the problem determined by the analysis unit 67 can be solved by the searched object case.

If it is determined by the case check unit 69 that the problem cannot be solved by the searched case, the case modification unit 70 modifies the searched object case such that the problem can be solved.

The case determination unit 71 determines whether or not the problem was able to be solved by agent processing according to the object case. The case determination unit 71 determines whether or not anonymization is necessary for the object case which was able to be solved such that the driver's personal information cannot be identified for managing it as the agent data.

If it is determined by the case determination unit 71 that the anonymization is necessary, the case anonymization unit 72 anonymizes information regarding the case by which the problem was able to be solved by k-anonymization, for example.

The case verification unit 73 verifies whether or not the case by which the problem was able to be solved is a falsified case.

The agent data use management unit 64 accumulates data regarding cases as a case database in the agent data. Each of those cases is not falsified and is the case by which the problem was able to be solved, which is anonymized in a manner that depends on needs. Then, by using the agent data in which the cases are accumulated, the agent data use management unit 64 executes the function as the agent in the subsequent processing. As a result, due to the accumulation of the cases, the learning for exerting the function as the agent is repeated and the processing precision is enhanced.

It should be noted that the learning set forth herein refers to repeating processing of searching for and modifying the agent data for solving the problem by using agent data that is learning data required for exerting the agent function, executing processing of solving the problem, and accumulating the contents of the executed processing as the agent data.

Moreover, the agent data that is the learning data includes not only the processing contents (case) executed for solving the problem by using the search result and the modification result for solving the problem but also various types of data acquired from the hardware when the user uses the hardware.

For example, in a case where the hardware is a vehicle, the various types of data are a location of occurrence of heavy braking, a time thereof, and a state (being awake, sleeping, heart rate, and the like) of a driver who is a user at that time, a location of unsteady driving or a slip, a time thereof, and a driver's state at that time, a location of a lane departure, a time thereof, and a driver's state at that time, a location of red-light violation or passing (overtaking), a time thereof, and a driver's state at that time, and a location of an accident, a time thereof, and a driver's state at that time, and the like. That is, it can also be said that in the case where the hardware is the vehicle, the agent data that is the learning data includes data indicating an operation state of the vehicle that is the hardware and data indicating behavior of the driver, i.e., a driving history as well as the contents executed for solving the problem.

In addition, the data indicating the operation state of the hardware also includes data obtained by executing software for controlling the operation of the hardware, data externally acquired for controlling the operation of the hardware, for example, data obtained from the cloud server, and the like.

The server 12 is constructed by at least one server in the network 13 such as the cloud server. The server 12 stores the agent data of the vehicles 11-1 to 11-n and includes a control unit 91, a communication unit 92, and a storage unit 93.

The control unit 91 generally controls operations of the server 12. The communication unit 92 includes an Ethernet (registered trademark) board, for example. The communication unit 92 communicates with the vehicle 11 via the network 13 and sends and receives various types of data. The storage unit 93 stores agent data registered in association with at least either of the vehicle 11 and the user.

<Agent Processing>

Next, agent processing by the agent system of FIG. 1 will be described with reference to a flowchart of FIG. 2.

In Step S11, the authentication unit 61 determines whether or not the driver gets in the vehicle on the basis of information supplied from the operation input unit 33, the vehicle operation detection unit 34, and the image pickup unit 39. That is, for example, when information indicating getting in the vehicle is input by operating the operation input unit 33, for example, when the vehicle operation detection unit 34 detects that operations including, for example, unlocking, opening a door, and activating are performed, or, for example, when a face image as an image of the area inside the vehicle, which is picked up by the image pickup unit 39, is detected near a driver's seat, the authentication unit 61 determines that the driver gets in the vehicle. Then, the processing proceeds to Step S12. It should be noted that the processing of Step S11 is repeated until getting in the vehicle is detected.

In Step S12, the authentication unit 61 executes authentication processing and authenticates the driver.

<Authentication Processing>

Here, authentication processing will be described with reference to a flowchart of FIG. 3.

In Step S41, the authentication unit 61 displays an authentication image start image, for example, as shown in FIG. 4.

In FIG. 4, the image “Login” is displayed and a button B1 to be operated when an ID is input is displayed shown as “Enter ID” on the top center side. In addition, “Please make predetermined operation for fingerprint authentication/device authentication” is displayed therebelow, which instructs to perform a corresponding predetermined operation in a case of, for example, fingerprint authentication, device authentication using a face image and the like, or the like, which is also available other than the method of inputting the ID and the password.

For example, the following configuration is provided. In this configuration, when the button B1 is operated, an ID input field C1 as “ID”, a password input field C2 as “Password”, and a keyboard C3 are displayed from above as shown in FIG. 5. Then, the ID and the password can be input by selecting the ID input field C1 and the password input field C2 by the use of a pointer or the like and operating the keyboard C3 with the operation input unit 33.

In addition, a button C4 shown as “Complete” indicating completion after the ID and the password are input is displayed.

In Step S42, the authentication unit 61 determines whether or not the ID and the password are input, and the processing of Steps S41 and S42 is repeated until it is determined that the ID and the password are input. Then, in Step S42, for example, when the ID and the password are input by selecting the ID input field C1 and the password input field C2 and operating the keyboard C3 with the operation input unit 33 and the button C4 is operated, it is determined that the ID and the password are input. Then, the processing proceeds to Step S43.

In Step S43, the authentication unit 61 controls the communication unit 35 to check matching between the input ID and password and ID and password registered in advance on the server 12. It should be noted that at this time, for example, the image shown as “Logging in” as shown in FIG. 6 is displayed.

Moreover, accordingly, the control unit 91 of the server 12 controls the communication unit 92 to acquire the sent ID and password. Then, the control unit 91 of the server 12 checks whether or not the acquired ID and password match the user's ID and password registered in advance in the storage unit 93. Then, the control unit 91 controls the communication unit 92 to send the check result to the vehicle 11 which has sent the ID and the password.

In Step S44, on the basis of the check result, the authentication unit 61 determines whether or not the IDs and the passwords match and the authentication is confirmed.

In Step S44, if the authentication is confirmed (authentication is OK), the authentication unit 61 recognizes in Step S45 that the authentication is confirmed.

On the other hand, in Step S44, if the authentication is not confirmed (authentication is not good (NG)), the authentication unit 61 recognizes in Step S46 that the authentication is not confirmed.

In the above-mentioned processing, the authentication processing is completed.

Now, referring back to the flowchart of FIG. 2, it will be described.

In Step S12, if the authentication processing is completed, the processing proceeds to Step S13.

In Step S13, the authentication unit 61 determines whether or not the authentication is confirmed (authentication is OK) on the basis of the authentication result.

In Step S13, if the authentication is not confirmed, the processing proceeds to Step S24.

In Step S24, the authentication unit 61 determines whether or not a request to set a new account is made by operating the operation input unit 33. In Step S24, if it is determined that the request to set the new account is made, the processing proceeds to Step S25.

In Step S25, the account management unit 62 controls the display unit 36 to display an image for setting the new account and receives input of an operation for setting the new account from the operation input unit 33.

In Step S26, the account management unit 62 sets the new account on the basis of information input by operating the operation input unit 33 and controls the communication unit 35 to cause the server 12 to register the new account. Then, the processing proceeds to Step S23.

Moreover, in Step S24, if the request to set the new account is not made, in Step S27, the authentication unit 61 controls the display unit 36 to indicate that the authentication is not confirmed (authentication is not good (NG)), for example, as shown in FIG. 7. Then, the processing proceeds to Step S23. It should be noted that in FIG. 7, “Login failed” is displayed indicating that the authentication is not confirmed.

In Step S23, on the basis of information supplied from the operation input unit 33, the vehicle operation detection unit 34, and the image pickup unit 39, the authentication unit 61 determines whether or not the driver gets off the vehicle. In Step S23, if it is determined that the driver gets off the vehicle, the processing returns to Step S12.

That is, if getting in the vehicle is confirmed but the authentication is not confirmed, a new account is set and the processing of Steps S12, S13, and S23 to S26 is repeated until the authentication is confirmed. The state in which the agent processing cannot be progressed continues until the user gets off the vehicle 11.

In Step S13, if the authentication is confirmed, the processing proceeds to Step S14.

In Step S14, the agent data synchronization management unit 63 controls the communication unit 35 to read from the server 12 the agent data of the driver (user) whose authentication is confirmed, and updates the agent data stored in its own storage unit 40 (synchronizes it with the agent data of the server 12).

In Step S15, on the basis of the agent data stored in the storage unit 40, the agent data synchronization management unit 63 generates an image for selecting available data and available actions as shown in FIG. 8, for example, and controls the display unit 36 to display the image.

In FIG. 8, data of the authenticated user, data applied to the vehicle A, and data associated with the user A, which is managed in the server 12, are displayed from above.

In FIG. 8, the agent data of the user A is shown as the data of the authenticated user. Moreover, individual-dependent data (Public), vehicle type-dependent data (Public), and general-purpose data (Public) are shown as the data applied to the vehicle A that is the vehicle 11 executing the series of processing of the agent. That is, it is indicated that the data applied to the vehicle A is currently the individual-dependent data (Public), the vehicle type-dependent data (Public), and the general-purpose data (Public).

In addition, it is indicated that the data associated with the user A includes data in a case of driving the vehicle B and data in a case of driving the vehicle C. As the data in the case of operating the vehicle B, individual-dependent data, vehicle type-dependent data (Public/Private), and general-purpose data (Public/Private) are shown. It is indicated that the data in the case of driving the vehicle B is the individual-dependent data, the vehicle type-dependent data (Public/Private), and the general-purpose data (Public/Private).

Moreover, as the data in the case of driving the vehicle C, individual-dependent data, vehicle type-dependent data, and general-purpose data (Public/Private) are shown. It is indicated that the data in the case of driving the vehicle B is the individual-dependent data, the vehicle type-dependent data, and the general-purpose data (Public/Private).

In addition, a button 111 shown as “used”, a button 112 shown as “transferred”, and a button 113 shown as “discarded” to be operated when selecting each of the use setting, the transfer setting, and the discard setting of the agent data are provided from the left at the bottom of FIG. 8.

<Configuration of Agent Data>

Here, a configuration of the agent data will be described with reference to FIG. 9.

The agent data includes three types of data of the individual-dependent data, the vehicle type-dependent data, and the general-purpose data. In addition, each of the types of data includes a Private type including information depending on the user and a Public type excluding it.

Thus, the Private type and the Public type are set for each of the three types of the individual-dependent data, the vehicle type-dependent data, the general-purpose data, and a total of six types of data are present as the agent data.

The individual-dependent data is data of the hardware (here, the vehicle) with the agent installed therein, the data being specific to an individual (indicating the hardware itself). More specifically, since the hardware is the vehicle, the individual-dependent data is, for example, a repair history, a distance travelled, remodeling information, a collision history, a residual amount of gasoline, and the like.

The vehicle type-dependent data is data common to the general vehicle type of the vehicle that is the hardware, and it is not limited to that individual. More specifically, since the hardware is the vehicle, the vehicle type-dependent data is fuel consumption, a maximum speed, information regarding whether or not travelling on a route navigated is possible, sensing data (e.g., automatic brake trigger condition and the like) of the vehicle operation detection unit 34, information regarding whether or not automatic driving is possible, a route travelled in automatic driving, and the like, which are commonly determined for each vehicle type.

The general-purpose data is generally applicable data not depending on the vehicle that is the hardware. More specifically, since the hardware is the vehicle, the general-purpose data is, for example, route information, near-store information, a visited-place history, a history of conversation with the agent, a drive manner, heavy braking, the number of times of honking, smoking or no-smoking, weather, three-dimensional data regarding buildings, roads, and the like, and external information, and the like.

Moreover, the data of the Private type is information depending on the driver who is a person using the vehicle that is the hardware. However, the data of the Private type does not need to be information with which the individual can be identified. For example, a travel history of travel histories, which includes a location and a time, is the data of the Private type.

In addition, the data of the Public type is data of a type which is not the data of the Private type. For example, the data of the Public type is simple route information, a travel history with which a location and a time cannot be identified, i.e., to which user the travel history relates cannot be identified, and the like.

Moreover, in FIG. 9, for each type of the agent data, an upper left part thereof represents whether or not it can be transferred to a different agent and a lower right part thereof represents whether or not it can be transferred to a different user. Here, the circle-mark indicates that it can be transferred, the x-mark indicates that it cannot be transferred, and the triangle-mark indicates that it can be transferred if the vehicle type is the same.

Since the agent differs in a manner that depends on the vehicles 11, transferring the agent data to the different agent refers to using a different agent by transferring agent data, which has been used by the same user in a case of driving a different vehicle A, to an agent of a different vehicle B.

Moreover, transferring the agent data to the different user refers to using an agent by transferring agent data of a different user B to the agent of the vehicle 11 used by the user A in a case where the user B drives the vehicle 11.

That is, regarding the individual-dependent data, either of data of the Public type and data of the Private type cannot be transferred to the different agent.

Moreover, regarding the vehicle type-dependent data, both of data of the Public type and data of the Private type can be transferred to the different agent if the vehicle types are the same. However, if the vehicle types are different, either of data of the Public type and data of the Private type cannot be transferred to the different agent.

In addition, regarding the general-purpose data, both of data of the Public type and data of the Private type can be transferred to the different agent.

The data of the Private type of all of the individual-dependent data, the vehicle type-dependent data, and the general-purpose data can include personal information and is specific to the user, and thus cannot be transferred to the different user.

Moreover, the data of the Public type of all of the individual-dependent data, the vehicle type-dependent data, and the general-purpose data is not specific to the user, and thus can be transferred to the different user.

Now, referring back to the display example of FIG. 8, it will be described. That is, the agent data is configured in this manner. The individual-dependent data (Public), the vehicle type-dependent data (Public), and the general-purpose data (Public) exemplified as the data applied to the vehicle A in FIG. 8 are data associated with the vehicle A. The authenticated user A has not driven the vehicle A. Thus, these are all data that can be transferred to the different user. Thus, these have been applied.

Moreover, as the data in the case of driving the vehicle B, which is the data associated with the user A, the individual-dependent data, the vehicle type-dependent data (Public/Private), and the general-purpose data (Public/Private) are shown. The vehicle type-dependent data (Public/Private) and the general-purpose data (Public/Private), to which “(Public/Private)” is added, indicate that these are data that can be transferred as shown in FIG. 9. Therefore, as shown in FIG. 9, the individual-dependent data to which “(Public/Private)” is not added, cannot be transferred.

That is, here, it is indicated that the vehicle type-dependent data (Public/Private) can be transferred because the vehicle A is of the same vehicle type as the vehicle B.

In addition, as the data in the case of driving the vehicle C, which is the data associated with the user A, the individual-dependent data, the vehicle type-dependent data, and the general-purpose data (Public/Private) are shown. The general-purpose data (Public/Private) to which “(Public/Private)” is added indicates that it is the data that can be transferred as shown in FIG. 9. Therefore, as shown in FIG. 9, the individual-dependent data and the vehicle type-dependent data to which “(Public/Private)” is not added cannot be transferred.

Here, it is indicated that the vehicle type-dependent data cannot be transferred because the vehicle A is not of the same vehicle type as the vehicle C.

Now, referring back to the flowchart of FIG. 2, it will be described.

In Step S16, the agent use management unit 64 determines whether or not an instruction to perform the use setting of the agent data is given by operating the operation input unit 33 and pressing the button 111 shown as “used” of FIG. 8.

In Step S16, if it is determined that the instruction to perform the use setting is given, in Step S17, the agent use management unit 64 executes use setting processing of the agent data. Then, the processing proceeds to Step S23. It should be noted that the use setting processing will be described later in detail with reference to a flowchart of FIG. 10.

On the other hand, in Step S16, if it is determined that the instruction to perform the use setting is not given, the processing proceeds to Step S18.

In Step S18, the agent transfer management unit 65 determines whether or not an instruction to perform the transfer setting of the agent data is given by operating the operation input unit 33 and pressing the button 112 shown as “transferred” of FIG. 8.

In Step S18, if it is determined that the instruction to perform the transfer setting is given, in Step S19, the agent transfer management unit 65 executes transfer setting processing of setting the transfer of the agent data. Then, the processing proceeds to Step S23. It should be noted that the transfer setting processing will be described later in detail with reference to a flowchart of FIG. 12.

On the other hand, in Step S18, if it is determined that the instruction to perform the transfer setting is not given, the processing proceeds to Step S20.

In Step S20, the agent discard management unit 66 determines whether or not an instruction to perform the discard setting of the agent data is given by operating the operation input unit 33 and pressing the button 113 shown as “discarded” of FIG. 8.

In Step S20, if it is determined that the instruction to perform the discard setting is given, in Step S21, the agent discard management unit 66 executes discard setting processing of setting the discard of the agent data. Then, the processing proceeds to Step S23. It should be noted that the discard setting processing will be described later in detail with reference to a flowchart of FIG. 15.

On the other hand, in Step S20, if it is determined that the instruction to perform the discard setting is not given, the processing proceeds to Step S22.

In Step S22, the analysis unit 67 executes agent function execution processing of executing the agent function, and proceeds to Step S23. It should be noted that the agent function execution processing will be described later in detail with reference to a flowchart of FIG. 17.

In accordance with the above-mentioned series of processing, the agent processing is executed, and it becomes possible to realize driving of the vehicle 11 using the agent function. Moreover, it becomes possible to transfer the agent data required for using the agent function to another user and to transfer that agent data for using it in another vehicle.

<Use Setting Processing>

Next, the use setting processing will be described with reference to the flowchart of FIG. 10.

In Step S71, the agent data use management unit 64 displays an image for setting the use of the agent data as shown in FIG. 11, for example. Here, in FIG. 11, as the data applied to the vehicle A, buttons 131 to 133 shown as “Applied” are each displayed on the right side of each of the individual-dependent data (Public), the vehicle type-dependent data (Public), and the general-purpose data (Public). Every time it is pressed, it is applicable. “Apply” indicating that it has not been applied and “Applied” indicating that it has been applied are sequentially switched and displayed and are set in a state corresponding to the displayed state. In FIG. 11, these are set to be applied by default. Thus, the buttons 131 to 133 is shown as “Applied”.

Regarding the data that can be transferred to that vehicle A from the server 12, which is associated with the user A, as the data in the case of driving the vehicle B, the individual-dependent data displayed in gray indicating that it cannot be used, the vehicle type-dependent data (Public/Private), and the general-purpose data (Public/Private) are displayed. Buttons 134 and 135 shown as “Apply” in a manner similar to that described above are displayed with respect to the vehicle type-dependent data (Public/Private) and the general-purpose data (Public/Private).

In addition, regarding the data that can be transferred to that vehicle A from the server 12, which is associated with the user A, as the data in the case of driving the vehicle C, the individual-dependent data and the vehicle type-dependent data which are displayed in gray indicating that these cannot be used and the general-purpose data (Public/Private) are displayed. A button 136 shown as “Apply” in a manner similar to that described above is displayed with respect to the general-purpose data (Public/Private).

In Step S72, the agent data use management unit 64 determines whether or not the buttons 131 to 135 are operated by operating the operation input unit 33, and if it is determined that these are operated, the processing proceeds to Step S73.

In Step S73, the agent data use management unit 64 updates the agent data stored in the storage unit 40 in accordance with the operation contents of the operation input unit 33 on the buttons 131 to 135.

In Step S74, the agent data use management unit 64 determines whether or not an instruction to terminate the use setting is given by operating the operation input unit 33. If the instruction to terminate the use setting is not given, the processing returns to Step S71 and the processing thereafter is repeated.

Moreover, in Step S72, if the operation input unit 33 is not operated, the processing of Step S73 is skipped.

That is, the processing of Steps S71 to S74 is repeated until the instruction to terminate the use setting is given. Then, in Step S74, if the instruction to terminate the use setting is given, the use setting ends.

In the above-mentioned processing, it becomes possible to set whether or not to apply applicable data of the agent data.

<Transfer Setting Processing>

Next, the transfer setting processing will be described with reference to the flowchart of FIG. 12.

In Step S101, the agent data transfer management unit 65 displays an image for setting the transfer of the agent data as shown in FIG. 13, for example. Here, in FIG. 13, “Please select destination” is shown, and buttons 151 to 153 shown as “Vehicle D (scheduled to be used at 16:00 on 9th February 2016. Taxi AA)”, “Vehicle E (owned by friend B)”, and “Vehicle F (owned by user A)” for selecting the vehicle 11 that can be selected as a transfer destination are displayed from above. It should be noted that items therebelow are similar to the items in FIG. 8. Thus, descriptions thereof will be omitted.

That is, the buttons 151 to 153 capable of selecting the vehicle D, E, or F that can be used by the authenticated user, to which the agent data can be transferred, are displayed.

In Step S102, the agent data transfer management unit 65 determines whether or not the buttons 151 to 153 are operated by operating the operation input unit 33.

In Step S102, for example, when the button 151 is pressed, it is determined that it is operated. Then, the processing proceeds to Step S103.

In Step S103, the agent data transfer management unit 65 updates the agent data stored in the storage unit 40 in accordance with the operation contents of the operation input unit 33 on the buttons 151 to 153.

That is, when the button 151 is pressed, the agent data transfer management unit 65 switches the display to indicate that the button 151 is selected as shown in FIG. 14, and displays the data applied to the vehicle A, the general-purpose data (Public) of each of the vehicles B and C, and buttons 171 to 173 shown as “Transfer”, which are capable of selecting whether or not to transfer the general-purpose data (Public/Private). Here, the vehicle D is not of the same type as all the vehicle types of the vehicles A, B, and C. Thus, it is indicated that the transfer of the vehicle type-dependent data (Public/Private) is not allowed.

In Step S104, the agent data transfer management unit 65 determines whether or not an instruction to terminate the use setting is given by operating the operation input unit 33. If the instruction to terminate the use setting is not given, the processing returns to Step S101 and the processing thereafter is repeated.

In this case, in Step S102, in the state displayed as shown in FIG. 14, whether or not an operation is input is determined again. When any of the buttons 171 to 173 is operated, for example, it is determined that the operation is input. Then, the processing proceeds to Step S103 again.

In Step S103, the agent data transfer management unit 65 sets the transfer of data of any of the buttons 171 to 173 with which the operation is input. Then, the processing proceeds to Step S104.

Then, in Step S104, if the instruction to terminate the transfer setting is given, the transfer setting ends.

In the above-mentioned processing, the agent data is set such that the data applied to the vehicle A, the general-purpose data (Public/Private) of each of the vehicles B and C, which corresponds to at least any selected button 171 to 173. and the general-purpose data (Public/Private) are transferred to the vehicle 11 that is “Vehicle D (scheduled to be used at 16:00 on 9th February 2016. Taxi AA)”.

It should be noted that the rule in transfer processing of each of the individual-dependent data, the vehicle type-dependent data, the general-purpose data, and the data of the Private type and the Public type in the agent data may be different from that described with reference to FIG. 9.

For example, the circle-mark, the triangle-mark, and the x-mark in FIG. 9 can be changed by the user as a change pattern 1 in place of those of FIG. 9. It should be noted that a change from the circle-mark to the triangle-mark and a change from the triangle-mark to the x-mark are possible but inverse changes thereof are impossible.

Moreover, as a change pattern 2, the kinds of the individual-dependent data, the vehicle type-dependent data, and the general-purpose data in the figure can be changed by the user. It should be noted that a change from the general-purpose data to the vehicle type-dependent data and a change from the vehicle type-dependent data to the individual-dependent data are possible but inverse changes thereof are impossible.

In addition, as a change pattern 3, the kinds of the Private type and the Public type in the figure can be changed by the user. It should be noted that a change from the Public type to the Private type is possible but an inverse change thereof is impossible.

That is, the data that can be transferred may be replaced by the data that cannot be transferred. However, the data that cannot be transferred is prevented from being replaced by the data that can be transferred. Thus, it becomes possible to protect the privacy while giving flexibility to the rule of the transfer processing. That is, in a case of changing the Public type to the Private type, since the Public type is the data that can be transferred, setting the Public type to be the data that cannot be transferred does not affect the privacy. However, if an inverse operation thereof is performed, the privacy is available to the public, and the privacy is not protected. Thus, such processing is impossible.

<Discard Setting Processing>

Next, the discard setting processing will be described with reference to the flowchart of FIG. 15.

In Step S121, the agent data discard management unit 66 displays an image for setting the discard of the agent data as shown in FIG. 16, for example. Here, in FIG. 16, buttons 191 to 199 shown as “Discard” to be operated when giving a discard instruction are each provided with respect to each of the individual-dependent data (Private), the vehicle type-dependent data (Private), and the general-purpose data (Private) as the data applied to the vehicle A, the individual-dependent data (Public/Private), the vehicle type-dependent data (Public/Private), and the general-purpose data (Public/Private) as the data in the case of driving the vehicle B, and the individual-dependent data (Public/Private), the vehicle type-dependent data (Public/Private), and the general-purpose data (Public/Private) as the data in the case of driving the vehicle C.

That is, here, the vehicle A and the user A are not registered in association with each other. Thus, regarding the data applied to the vehicle A, only the individual-dependent data (Private), the vehicle type-dependent data (Private), and the general-purpose data (Private) are shown, and it is indicated that all of them do not have a privilege to discard (Public) is shown.

In Step S122, the agent data discard management unit 66 determines whether or not the buttons 131 to 135 are operated by operating the operation input unit 33, and if it is determined that these are operated, the processing proceeds to Step S123.

In Step S123, the agent data discard management unit 66 updates the agent data stored in the storage unit 40 in accordance with the operation contents of the operation input unit 33 on the buttons 191 to 199.

In Step S124, the agent data discard management unit 66 determines whether or not an instruction to terminate the use setting is given by operating the operation input unit 33. If the instruction to terminate the use setting is not given, the processing returns to Step S121 and the processing thereafter is repeated.

Moreover, in Step S122, if the operation input unit 33 is not operated, the processing of Step S123 is skipped.

That is, the processing of Step S121 to S124 is repeated until the instruction to terminate the discard setting is given. Then, in Step S124, if the instruction to terminate the discard setting is given, the discard setting ends.

In the above-mentioned processing, it becomes possible to set whether or not to discard data of the agent data, which can be discarded.

<Agent Function Execution Processing>

Next, the agent function execution processing using the agent data set in the above-mentioned processing will be described with reference to the flowchart of FIG. 17.

In Step S141, the analysis unit 67 receives supply from the vehicle operation detection unit 34, the audio input unit 38, and the image pickup unit 39, the supply including the various detection results in the vehicle 11 such as a detection result of a vehicle operation, input audio, a picked-up image, and the like.

In Step S142, the analysis unit 67 analyzes the received various detection results, sets a case that becomes a problem corresponding to an analysis result as the object case, and supplies it to the case search unit 68. For example, if a driver who is a user utters a voice including a destination and the like in order to give a navigation instruction, the analysis unit 67 subjects the voice input into the audio input unit 38 to linguistic analysis, semantic analysis, and the like, recognizes that route search is a problem, sets the search for a route to the destination as the object case, and supplies it to the case search unit 68.

In Step S143, on the basis of the agent data stored in the storage unit 40, the case search unit 68 searches for the case that becomes processing for solving the object case. The case search unit 68 searches for route candidates R1, R2, . . . Rn to be selected, for example, a route search history and the like included in the agent data, and outputs them as a case search result.

In Step S144, the case check unit 69 checks whether or not the object case that becomes the problem can be solved on the basis of the data that becomes the case search result.

For example, regarding a route from a start point X to a destination Y in a route search result R1, it is assumed that a route R1 from the start point X to a stop A, a route R2 from the stop A to a stop B, and a route R3 from the stop B to the destination Y, which are fragmented routes from the start point X to the destination Y, are found as search results, respectively, from cases in the past. In this case, for example, the routes R1 and R3 have no problems. However, the route R2 is a route when the user A used a vehicle H in the past and the vehicle A currently driven by the user A has a vehicle width larger than that of the vehicle H, and thus handling on the road width of the route R2 may be difficult. In this case, it is determined that the object case cannot be solved by the case search result. In Step S144, if it is determined that the problem cannot be solved by the object case in this manner, the processing proceeds to Step S145.

In Step S145, the case modification unit 70 modifies the case search result such that the object case can be solved. That is, regarding the above-mentioned case search result, the route R2 is modified as a route R2′ by, for example, using the agent data to search for a route available to the vehicle width of the vehicle A in the route R2, such that the problem can be solved by the object case by consequently using the routes R1, R2′, and R3 as the route from the start point X to the destination Y. It should be noted that even if such modification is made, the object case cannot be necessarily overcome.

In Step S146, the case determination unit 71 executes the case search result for solving the object case set in this manner. That is, in this example, the case determination unit 71 controls the display unit 36 to display an image for navigation to the destination Y and controls the audio output unit 37 to output a voice for guidance to the destination Y.

It should be noted that in Step S144, if the object case can be solved, the processing of Step S145 is skipped. That is, in this case, the initial case search result is used as it is for solving the object case.

In Step S147, the case determination unit 71 determines whether or not the problem of the object case was able to be solved on the basis of the case search result in the series of operations. That is, in this case, the case determination unit 71 determines whether or not the vehicle 11 was able to be moved from the start point X to the destination Y owing to navigation based on the case search result.

In Step S147, if the object case was able to be solved, in Step S148, the case determination unit 71 considers the case search result as the success case.

Moreover, in Step S147, if the object case was not able to be solved, in Step S149, the case determination unit 71 considers the case search result as the success case.

In Step S150, the case anonymization unit 72 determines whether or not anonymization is necessary for this case search result. For example, regarding this case search result, there is a fear that information including the personal information of the user A is kept as the general-purpose data of the Private type indicating that the user A moved from the start point X to the destination Y at predetermined date and time. In view of this, in a case where such personal information is kept, the case anonymization unit 72 determines that anonymization is necessary for using the case search result as the general-purpose data of the Public type. Then, the processing proceeds to Step S151.

In Step S151, the case anonymization unit 72 anonymizes this case search result. Anonymizing is anonymizing by k-anonymization processing, for example. Here, the k-anonymization processing is processing of converting into information with which the user A cannot be identified by using information regarding a plurality of similar case search results such that it can be information indicating that at least k people moved from the start point X to the destination Y, for example. In other words, the k-anonymization processing is converting a data attribute associated with the information indicating that the movement from the start point X to the destination Y has been performed, such that the user A cannot be identified.

For example, the case anonymization unit 72 controls the communication unit 35 to access the server 12, searches for the information indicating that the movement from the start point X to the destination Y has been performed, and determines a plurality of case search results of k people or more. The case anonymization unit 72 converts the information indicating the user A moved from the start point X to the destination Y on a predetermined date D into information of the k people or more indicating that a plurality of people who are the k people or more moved from the start point X to the destination Y for a predetermined year (also including the predetermined date D).

In this manner, the date and time at which this data was generated becomes vague information. Therefore, only the “information indicating that movement from the start point X to the destination Y has been performed” is provided as the information with which the user A cannot be identified.

Regarding the case search result anonymized in this manner, the case anonymization unit 72 changes attributes from the general-purpose data of the Private type to the general-purpose data of the Public type. By accumulating the general-purpose data of the Public type attribute-converted in this manner, data that can be referred for route search in other agents increases. Thus, it becomes possible to perform the case search with higher precision.

It should be noted that in Step S150, for example, if the case search result can be considered as the general-purpose data of the Public type, it is determined that the anonymization is not necessary, and the processing of Step S151 is skipped.

In Step S152, the case verification unit 73 determines whether or not the case search result including the general-purpose data of the Public type is falsified data, and if it is determined that the case search result is not the falsified data, in Step S153, the case verification unit 73 stores the case search result as the agent data stored in the storage unit 40 and causes the storage unit 93 of the server 12 to store the case search result. At this time, the case verification unit 73 stores the case search result including the general-purpose data of the Public type as the agent data as well as the information indicating whether the object case is the success case or the failure case.

It should be noted that in Step S152, if it is determined that the case search result, the case search result including the general-purpose data of the Public type is falsified, the processing of Step S153 is skipped and the case search result is not registered as the general-purpose data of the Public type.

In Step S154, the analysis unit 67 determines whether or not an instruction to terminate the agent function execution processing is given by operating the operation input unit 33, and if the instruction to terminate the agent function execution processing is not given, the processing returns to Step S141 and the processing thereafter is repeated. Then, in Step S154, if the instruction to terminate the agent function execution processing is given, the processing ends.

In the above-mentioned processing, even in a case of changing vehicles having the agent function, it becomes possible to transfer the agent data accumulated by the agent function. That is, in a case where the user A changes vehicles from the vehicle A to the vehicle B, i.e., in a case where the user A changes agents from the agent of the vehicle A to the agent of the vehicle B, the individual-dependent data of the vehicle A out of the agent data accumulated in the vehicle A has no relationship with the vehicle B, and thus it is impossible to transfer the individual-dependent data of the vehicle A to the vehicle B. However, by transferring the general-purpose data of the vehicle A, it becomes possible to transfer operations, settings, and the like, which have been customized. Moreover, it becomes possible to transfer the vehicle type-dependent data as it is if the vehicles A and B are of the same vehicle type.

In addition, in a case where the user B who is a new user uses the vehicle A as a secondhand car, any of the individual-dependent data, the vehicle type-dependent data, and the general-purpose data of the data of the Private type cannot be transferred while all the data of the Public type can be transferred.

In accordance with such processing, it becomes possible to suitably transfer the agent data while protecting the privacy.

Moreover, the above-mentioned data of the Private type may be deleted from the vehicle 11 after it may be stored in the server 12 right before the user gets off the vehicle 11, and it may be downloaded and used from the server 12 every time the user gets in the vehicle 11. With this management, it becomes possible to prevent the data of the Private type from being stolen even if the vehicle 11 is stolen.

In addition, for example, also in a case where the vehicle 11 of the same vehicle type as the owned vehicle 11 is borrowed as a rental car or in a case where the vehicle 11 of the same fixed vehicle type is always borrowed as a shared car or the like, it becomes possible to use the vehicle type-dependent data and the general-purpose data as its own agent data anytime by downloading the agent data from the server 12 to thereby transfer it every time.

Moreover, although the example in which the navigation function of the vehicle 11 is realized by using the agent has been described above, another object may be made function as the agent.

For example, it may be an agent that realizes a function of outputting a guidance voice for assisting a speed, an accelerator, and a brake depending on a road condition on the basis of the speed, road inclination, the accelerator, and information regarding correlation between the brake and fuel consumption, and the like.

Moreover, it may be an agent that manages a history of sudden starts and heavy braking, an accident history, a number-of-battery charges history, a travel history (history of contact with deterioration factors such as seaside, dessert, and volcanic ash), a dust and smell sensor history, and the like as information for setting a residual value of the vehicle.

In addition, it may be an agent that manages information that can provide the vehicle with added-values, such as a history of destinations (information regarding a vehicle's legend, for example, driving in the Antarctica . . . ), vehicle's rarity (number of vehicles travelling in a particular region), a driver history (user history: sex, and the like, for woman only, for example).

Moreover, as the number of case search results accumulated increases, the added-value of that vehicle increases. Therefore, the amount of accumulation of case search results may be indicated as visualized information that becomes a quantitative index as the amount of data ( . . . GB retained), for example.

In addition, by comparing the above-mentioned residual value and the added-value with those of a secondhand vehicle distributed in the market, information indicating that it is equivalent to . . . yen as a value in money may be displayed.

<Example of Execution by Software>

By the way, the above-mentioned series of processing may be executed by hardware or may be executed by software. When the series of processing is executed by software, programs configuring the software are installed from a recording medium into a computer incorporated in dedicated hardware, a general-purpose personal computer, for example, capable of executing various functions by installing various programs, or the like.

FIG. 18 shows a configuration example of the general-purpose personal computer. This personal computer includes a built-in central processing unit (CPU) 1001. An input/output interface 1005 is connected to the CPU 1001 via a bus 1004. A read only memory (ROM) 1002 and a random access memory (RAM) 1003 are connected to the bus 1004.

An input unit 1006, an output unit 1007, a storage unit 1008, and a communication unit 1009 are connected to the input/output interface 1005. The input unit 1006 includes input devices such as a keyboard and a mouse with which the user inputs an operation command. The output unit 1007 outputs a processing operation screen and an image of a processing result to the display device. The storage unit 1008 includes a hard disk drive and the like that stores programs and various types of data. The communication unit 1009 includes a local area network (LAN) adaptor and the like and executes communication processing via a network represented by the Internet. Moreover, a drive 1010 is connected thereto. The drive 1010 reads and writes data from/in a removable medium 1011 such as a magnetic disk (including a flexible disk), an optical disc (including compact disc-read only memory (CD-ROM) and digital versatile disc (DVD)), a magneto-optical disk (including a Mini Disc (MD)), and a semiconductor memory.

The CPU 1001 executes various types of processing in accordance with programs stored in the ROM 1002 or programs read from the removable medium 1011 such as the magnetic disk, the optical disc, the magneto-optical disk, and the semiconductor memory, installed in the storage unit 1008, and loaded in the RAM 1003 from the storage unit 1008. In the RAM 1003, data and the like required for the CPU 1001 to execute various types of processing are further stored as appropriate.

In the computer configured in the above-mentioned manner, the above-mentioned series of processing is performed by the CPU 1001 loading and executing the programs stored in the storage unit 1008 in the RAM 1003 via the input/output interface 1005 and the bus 1004, for example.

The programs executed by the computer (CPU 1001) can be provided, recorded in the removable medium 1011 as a package medium or the like, for example. Moreover, the programs can be provided via a wired or wireless transmission medium such as a local area network, the Internet, and digital satellite broadcasting.

In the computer, the programs can be installed in the storage unit 1008 via the input/output interface 1005 by mounting the removable recording medium 1011 on the drive 1010. Moreover, the programs can be received by the communication unit 1009 and installed in the storage unit 1008 via the wired or wireless transmission medium. Otherwise, the programs can be installed in advance in the ROM 1002 or the storage unit 1008.

It should be noted that the programs executed by the computer may be programs whose processes are sequentially performed in the order described in the present specification or may be programs whose processes are concurrently performed or at a necessary timing, for example, upon calling.

Moreover, in the present specification, the system means a collection of a plurality of components (apparatuses, modules (parts), and the like) and it does not matter whether or not all the components are provided inside the same casing. Therefore, a plurality of apparatuses housed in separate casings and connected via a network and a single apparatus including a plurality of modules housed in a single casing are both systems.

It should be noted that embodiments of the present disclosure are not limited to the above-mentioned embodiment and various modifications can be made without departing from the gist of the present disclosure.

For example, the present disclosure can take a cloud computing configuration in which one function is shared and cooperatively processed by a plurality of apparatuses via a network.

Moreover, the steps described above with reference to the above-mentioned flowcharts can be shared and executed by a plurality of apparatuses rather than being executed by a single apparatus.

In addition, in a case where a single step includes a plurality of processes, the plurality of processes of the single step can be shared and executed by a plurality of apparatuses rather than being executed by a single apparatus.

It should be noted that the present disclosure can also take the following configurations.
<1> An information processing apparatus, including:
   a storage unit that stores learning data in association with a user who uses hardware;
   an operation determination unit that determines an operation of the hardware on a basis of the learning data; and
   a presentation unit that presents an option of learning data available to the user out of the learning data stored in the storage unit, in which
   the operation determination unit determines an operation on a basis of learning data selected from the option presented by the presentation unit.
<2> The information processing apparatus according to <1>, in which
   the learning data includes private data depending on the user and public data other than the private data, and
   the presentation unit presents the public data as an option as learning data available to the operation determination unit out of the learning data stored in the storage unit.
<3> The information processing apparatus according to <2>, in which
   the learning data includes individual-dependent data depending on an individual of the hardware, type-dependent data depending on a type of the hardware, and general-purpose data not depending on the hardware, and
   the presentation unit presents, when the user uses other hardware different from the hardware and causes the operation determination unit of the other hardware to determine an operation, options including private data and public data of the general-purpose data out of learning data stored in association with the hardware.
<4> The information processing apparatus according to <3>, in which
   in a case where the hardware and the other hardware are of a same type, the presentation unit presents, when the user uses other hardware different from the hardware and causes the operation determination unit of the other hardware to determine an operation, options including private data and public data of each of the type-dependent data and the general-purpose data out of learning data stored in association with the other hardware.
<5> The information processing apparatus according to <4>, in which
   the presentation unit presents options for discarding each of the private data and the public data of the individual-dependent data, the type-dependent data, and the general-purpose data out of the learning data.
<6> The information processing apparatus according to <2>, in which
   the learning data is constructed for each hardware module used by the user, and
   the presentation unit presents
      another option for selecting the hardware to which the learning data is to be transferred, and
      an option of the learning data available to the operation determination unit of the hardware, the option being public data of learning data learned by the hardware used by the user out of the learning data stored in the storage unit.
<7> The information processing apparatus according to <2>, in which
   the learning data is constructed for each hardware module used by the user and includes individual-dependent data depending on an individual of the hardware, type-dependent data depending on a type of the hardware, and general-purpose data not depending on the hardware, and
   the presentation unit presents
      another option for selecting the hardware to which the learning data is to be transferred, and
      options of the learning data available to the operation determination unit of another hardware different from the hardware, the options being public data and private data of the general-purpose data of learning data learned by the hardware used by the user out of the learning data stored in the storage unit.
<8> The information processing apparatus according to any of <1> to <7>, in which
   the hardware is a vehicle,
   the learning data includes individual-dependent data depending on an individual of the vehicle, vehicle type-dependent data depending on four vehicle types of the vehicle, and general-purpose data not depending on the vehicle,
   the individual-dependent data includes a repair history, a distance travelled, remodeling information, a collision history, and a residual amount of gasoline,
   the vehicle type-dependent data includes fuel consumption, a maximum speed, information regarding whether or not travelling on a route navigated is possible, sensing data for detecting a vehicle operation, information regarding whether or not automatic driving is possible, and a route travelled in automatic driving, which are commonly determined for each vehicle type of the vehicle, and
   the general-purpose data includes route information, near-store information, a visited-place history, a history of conversation with an agent, a drive manner, heavy braking, number of honking times, smoking or no-smoking, weather, three-dimensional data regarding a building, a road, and the like, and external information.
<9> The information processing apparatus according to any of <1> to <8>, including
   an anonymization unit that anonymizes data regarding an operation determined on a basis of the learning data, in which
   the storage unit stores the data regarding the operation determined on the basis of the learning data by the operation determination unit in a state in which the data is anonymized by the anonymization unit.
<10> An information processing method for an information processing apparatus including
   a storage unit that stores learning data in association with a user who uses hardware,
   an operation determination unit that determines an operation of the hardware on a basis of the learning data, and
   a presentation unit that presents an option of learning data available to the user out of the learning data stored in the storage unit, the information processing method including:
   a step of determining, by the operation determination unit an operation on a basis of learning data selected from the option presented by the presentation unit.
<11> A program for a computer including
   a storage unit that stores learning data in association with a user who uses hardware,
   an operation determination unit that determines an operation of the hardware on a basis of the learning data, and
   a presentation unit that presents an option of learning data available to the user out of the learning data stored in the storage unit, the program causing the computer to execute
   processing of determining, by the operation determination unit an operation on a basis of learning data selected from the option presented by the presentation unit.

### REFERENCE SIGNS LIST

11, 11-1 to 11-n vehicle
12 server
13 network
31 control unit
32 vehicle drive unit
33 operation input unit
34 vehicle operation detection unit
35 communication unit
36 display unit
37 audio output unit
38 audio input unit
39 image pickup unit
40 storage unit
41 agent processing unit
61 authentication unit
62 account management unit
63 agent data synchronization management unit
64 agent data use management unit
65 agent data transfer management unit
66 agent data discard management unit
67 analysis unit
68 case search unit
69 case check unit
70 case modification unit
71 case determination unit
72 case anonymization unit
73 case verification unit
91 control unit
92 communication unit
93 storage unit

1. An information processing apparatus, comprising:
a storage unit that stores learning data in association with a user who uses hardware;
an operation determination unit that determines an operation of the hardware on a basis of the learning data; and
a presentation unit that presents an option of learning data available to the user out of the learning data stored in the storage unit, wherein
the operation determination unit determines an operation on a basis of learning data selected from the option presented by the presentation unit.

2. The information processing apparatus according to claim 1, wherein
the learning data includes private data depending on the user and public data other than the private data, and
the presentation unit presents the public data as an option as learning data available to the operation determination unit out of the learning data stored in the storage unit.

3. The information processing apparatus according to claim 2, wherein
the learning data includes individual-dependent data depending on an individual of the hardware, type-dependent data depending on a type of the hardware, and general-purpose data not depending on the hardware, and
the presentation unit presents, when the user uses other hardware different from the hardware and causes the operation determination unit of the other hardware to determine an operation, options including private data and public data of the general-purpose data out of learning data stored in association with the hardware.

4. The information processing apparatus according to claim 3, wherein
in a case where the hardware and the other hardware are of a same type, the presentation unit presents, when the user uses other hardware different from the hardware and causes the operation determination unit of the other hardware to determine an operation, options including private data and public data of each of the type-dependent data and the general-purpose data out of learning data stored in association with the other hardware.

5. The information processing apparatus according to claim 4, wherein
the presentation unit presents options for discarding each of the private data and the public data of the individual-dependent data, the type-dependent data, and the general-purpose data out of the learning data.

6. The information processing apparatus according to claim 2, wherein
the learning data is constructed for each hardware module used by the user, and
the presentation unit presents
another option for selecting the hardware to which the learning data is to be transferred, and
an option of the learning data available to the operation determination unit of the hardware, the option being public data of learning data learned by the hardware used by the user out of the learning data stored in the storage unit.

7. The information processing apparatus according to claim 2, wherein
the learning data is constructed for each hardware module used by the user and includes individual-dependent data depending on an individual of the hardware, type-dependent data depending on a type of the hardware, and general-purpose data not depending on the hardware, and
the presentation unit presents
another option for selecting the hardware to which the learning data is to be transferred, and
options of the learning data available to the operation determination unit of another hardware different from the hardware, the options being public data and private data of the general-purpose data of learning data learned by the hardware used by the user out of the learning data stored in the storage unit.

8. The information processing apparatus according to claim 1, wherein
the hardware is a vehicle,
the learning data includes individual-dependent data depending on an individual of the vehicle, vehicle type-dependent data depending on four vehicle types of the vehicle, and general-purpose data not depending on the vehicle,
the individual-dependent data includes a repair history, a distance travelled, remodeling information, a collision history, and a residual amount of gasoline,
the vehicle type-dependent data includes fuel consumption, a maximum speed, information regarding whether or not travelling on a route navigated is possible, sensing data for detecting a vehicle operation, information regarding whether or not automatic driving is possible, and a route travelled in automatic driving, which are commonly determined for each vehicle type of the vehicle, and
the general-purpose data includes route information, near-store information, a visited-place history, a history of conversation with an agent, a drive manner, heavy braking, number of honking times, smoking or no-smoking, weather, three-dimensional data regarding a building, a road, and the like, and external information.

9. The information processing apparatus according to claim 1, comprising
an anonymization unit that anonymizes data regarding an operation determined on a basis of the learning data, wherein
the storage unit stores the data regarding the operation determined on the basis of the learning data by the operation determination unit in a state in which the data is anonymized by the anonymization unit.

10. An information processing method for an information processing apparatus including
a storage unit that stores learning data in association with a user who uses hardware,
an operation determination unit that determines an operation of the hardware on a basis of the learning data, and
a presentation unit that presents an option of learning data available to the user out of the learning data stored in the storage unit, the information processing method comprising:
a step of determining, by the operation determination unit an operation on a basis of learning data selected from the option presented by the presentation unit.

11. A program for a computer including
a storage unit that stores learning data in association with a user who uses hardware,
an operation determination unit that determines an operation of the hardware on a basis of the learning data, and
a presentation unit that presents an option of learning data available to the user out of the learning data stored in the storage unit, the program causing the computer to execute
processing of determining, by the operation determination unit an operation on a basis of learning data selected from the option presented by the presentation unit.
